(19) United States
(12) Patent Application Publication
(10) Pub. No.: US 2013/0176257 A1
(43) Pub. Date: Jul. 11, 2013

(54) PORTABLE TERMINAL AND METHOD FOR EXECUTING FUNCTION KEY INCLUDED THEREIN

(71) Applicant: Samsung Electronics Co., Ltd., Gyeonggi-do (KR)

(72) Inventor: Soon-Sang PARK, Daegu (KR)

(73) Assignee: SAMSUNG ELECTRONICS CO., LTD., Gyeonggi-do (KR)

(21) Appl. No.: 13/738,244

(22) Filed: Jan. 10, 2013

(30) Foreign Application Priority Data
Jan. 10, 2012 (KR) 10-2012-0003033

(51) Int. Cl. G06F 3/01

(52) U.S. Cl. CPC G06F 3/01
USPC 345/173

(57) ABSTRACT

Provided are a portable terminal and a method for executing a function key in the portable terminal The portable terminal includes a main body, an on/off key provided on a top surface of the main body, and at least one side key provided on a side of the main body, in which the central on/off key and/or the side key are configured as touch keys. The method includes a first step of sensing a touch on the function key, a second step of sensing a touch on a malfunction sensing unit disposed near the function key, and a third step of executing an operation corresponding to the touch on the function key.

### CLAIM OF PRIORITY

This application claims the benefit under 35 U.S.C. §119(a) from a Korean Patent Application filed in the Korean Intellectual Property Office on Jan. 10, 2012 and assigned Serial No. 10-2012-0003033, the entire disclosure of which is hereby incorporated by reference in its entirety.

### BACKGROUND OF THE INVENTION

1. Field of the Invention

The present invention generally relates to a portable terminal and a method for executing a function key included therein, and more particularly, to a portable terminal in which a side key and/or a central on/off key are provided, and a method for executing a function key included in the portable terminal in order to improve the functionality and efficiency of the portable terminal use.

2. Description of the Related Art

Generally, a portable electronic device refers to a device which allows a user to enjoy various contents while the user is carrying the device, such as a portable terminal, an MP3 player, a Portable Multimedia Player (PMP), an electronic book, or the like. For the portable electronic device, a form factor is diversified according to the trend of the times, the purpose of the portable electronic device or consumers' needs. Recently, the use of bar-type portable terminals having multiple functions, such as a smart phone, a tablet PC, etc., have been increasing. In particular, as the bar-type portable terminal has been equipped with note or multimedia functions, users can enjoy various content and services, such as for example, banking services, game/multimedia services, wireless Internet services, business programs such as word processing or spreadsheet programs and other similar programs as well as voice communication, merely with the portable terminal In the bar-type portable terminal, a data input device for inputting data in front and a data output device for displaying an image may be implemented with a single large-size display panel.

In the bar-type portable terminal, there is typically provided a button for turning on/off the portable terminal, an enter and cancel key button, a key button for executing a camera function, a key button for adjusting a volume, key buttons for executing particular functions such as locking/unlocking a display panel, or the like are separately installed as a side key and a central on/off key on a side or a center of the portable terminal The separate side key or central on/off key is generally a mechanical button key provided to prevent malfunction or to enable execution of a particular function while the portable terminal is in an idle state (for example, initiating a power-off state for only the display panel aside from the power-on/off state of the portable terminal) or in another mode, e.g., turning up or down the volume of a sound during a call. A side key realized with a mechanical button key according to prior art is disclosed in Korean Patent Publication No. 10-2011-0055896, published on May 26, 2011 and entitled “Side Key Connection Device for Portable Terminal”.

FIG. 1 schematically shows a portable terminal viewed from front, which includes a side key or a central on/off key implemented with a mechanical button key, according to prior art, and FIG. 2 schematically shows the portable terminal of FIG. 1 viewed from back. Referring to FIGS. 1 and 2, a portable terminal 1 includes a main body 2 in the shape of a bar and a display panel 3. Although the main body 2 of the portable terminal 1 is described as having the bar shape, the shape thereof is not limited to the bar shape and thus the portable terminal may be of a folder type, a slide type, or other similar shapes known to one skilled in the art. In the embodiment depicted, on a front surface of the main body 2 are provided the display panel 3, a sound output unit 2a, a camera 2c, and a central on/off key 2b. The display panel 3 may typically occupy 90% or more of the front surface of the main body 2, and inputs or outputs data or displays an image on the screen in response to a touch by a user. On the main body 2, the sound output unit 2a and the camera 2c are disposed in an area adjacent to an upper portion of the display panel 3 and a microphone (MIC) or the central on/off key 2b are installed in an area adjacent to a lower portion of the display panel 3.

On a side surface of the main body 2 there is disposed a side key 4a for powering on/off the portable terminal 1 or directly executing the camera 2c, and on the other side surface of the main body 2 there is disposed an up/down side key 4b for turning up or down the volume of the portable terminal 1 or moving a menu or the like.

While the side keys 4a and 4b are described as being provided on the side surface and the other side surface of the main body 2, respectively, such a structure is merely an example of one particular embodiment, however at least one of side keys 4a and 4b may typically be installed according to functions. On the front surface of the main body 2, in the area adjacent to the lower portion of the display panel 3 is disposed the central on/off key 2b for switching on/off the idle state of the portable terminal 1 or selecting a menu. The side keys 4a and 4b disposed on the side surfaces of the main body 2 or the central on/off key 2b are provided as mechanical key buttons to operate by a user through applying a force of a predetermined level or higher, thus preventing the accidental or unintended activation during carrying of the portable terminal 1 and enhancing the sense of use by the user. If the side keys 4a and 4b or the central on/off key 2b are touch keys instead of the mechanical keys, functions unwanted by the user may be unintentionally activated or executed and a malfunction may occur due to a touch generated during carrying of the portable terminal 1.

Moreover, even when the side keys 4a and 4b or the central on/off key 2b are provided as mechanical button keys, they may be mistakenly pressed during carrying of the portable terminal 1, causing the unintended activation of a function or other malfunction. As a result, a program may be unintentionally initiated or a user's settings may be changed by the unintended activation or malfunction that is caused by the erroneous pressing of the side keys 4a and 4b or the central on/off key 2b. As a result, a user may need to take corrective action or reset their preferences, and thus causing significant inconvenience to the user. However, when the side keys 4a and 4b or the central on/off key 2b are provided as mechanical keys, they have to be disposed to fit into the main body 2 for assembly and have to undergo various assembly processes, making the assembly stage complicated. In addition, when the side keys 4a and 4b or the central on/off key 2b are provided as mechanical buttons, the keys protrude from the main body 2, interfering with the design of the portable terminal 1. Furthermore, by providing the side keys 4a and 4b or the central on/off key 2b as mechanical button keys, user's fatigue may be caused and frequent damage or breakdown may occur due to mechanical wear caused by frequent pressing or use. Foreign substances may also be easily introduced through the side keys 4a and 4b or the central on/off key 2b, and due to foreign substances infiltrating into spaces or gaps that exist around the mechanical button keys. This can result in the side keys 4a and 4b or the central on/off key 2b not functioning properly or even a problem may occur even in a circuit disposed in the main body 2.

Furthermore, if a user causes the portable terminal 1 to accidentally come into contact with water, the water is likely to be introduced into the portable terminal 1 through gaps around the side keys 4a and 4b or the central on/off key 2b, such that the user cannot use the portable terminal 1 itself or may have a difficulty in an after-service (AS) to have the portable terminal repaired.

### SUMMARY OF THE INVENTION

Accordingly, the present invention provides a portable terminal in which a function key, such as a side key or a central on/off key, which has been provided as a mechanical key button, executes a particular function by a touch, and a method for executing a function key included in the portable terminal

The present invention also provides a portable terminal which has a waterproof feature and does not easily permit the introduction of a foreign substance therein, and a method for executing a function key included in the portable terminal

The present invention also provides a portable terminal which is capable of preventing a side key or a central on/off key from malfunctioning due to a user's unintended or unwanted touch, and a method for executing a function key included in the portable terminal

According to an another aspect of the present invention, there is provided a portable terminal including a main body, an on/off key provided on a top surface of the main body, and at least one side key provided on a side of the main body, in which the central on/off key and/or the side key are configured as touch keys.

The central on/off key and/or the side key may include at least one malfunction sensing unit which is disposed around and on circumferences thereof, respectively, wherein the malfunction sensing unit may also include a touch sensor.

If a touch on the malfunction sensing unit is sensed when the central on/off key and/or the side key is touched, the central on/off key may be considered as erroneously touched. A particular function may be executed as the central on/off key and/or the side key is touched. That is, the particular function is performed when a malfunction sensing unit is not touched and the central on/off key or side key is touched.

The side key may include a first side touch key disposed on a side of the main body to execute by being touched a particular function and a second side touch key disposed on the other side of the main body to execute by being touched a particular function, which is different from the function of the first side touch key,.

The malfunction sensing unit may include a first touch sensor disposed around the circumference of the central on/off key to sense an erroneous or unintended touch on the central on/off key and/or the side key and a second touch sensor disposed on the circumference of the side key to sense an erroneous or unintended touch on the central on/off key and/or the side key.

The second touch sensor may include a first side touch sensor disposed on the circumference of the first side key and a second side touch sensor disposed on the circumference of the second side key.

A pattern for sensing a touch on the first touch sensor and the second touch sensor may be formed on the first touch sensor and the second touch sensor.

If the first side touch key and the second side touch key are touched at the same time when the malfunction sensing unit is not touched, locking of a touch panel provided in the portable terminal may be turned on or off.

If the first and second side touch keys and the central on/off key are touched at the same time when the malfunction sensing unit is not touched, the portable terminal may be powered on or off

According to another aspect of the present invention, there is provided a portable terminal including a touch panel disposed in a main body of the portable terminal, in which function keys disposed in the portable terminal include touch keys that may sense an erroneous touch on the function keys.

The function keys may include a central on/off key disposed apart from the touch panel, a side key disposed on a side of the main body, and a malfunction sensing unit including a first touch sensor disposed around the circumference of the central on/off key and a second touch sensor disposed on the circumference of the side key.

The first touch sensor and the second touch sensor may have a higher touch recognition rate, (in other words, the first and second touch sensor may have greater sensitivity) than the side key and the central on/off key.

If a touch on the first touch sensor and/or the second touch sensor is sensed when the central on/off key is also touched, then a touch on the central on/off key may be considered as erroneously touched.

If a touch on the first touch sensor and/or the second touch sensor is sensed when the side key is also touched, then a touch on the side key may be considered as erroneously touched.

Therefore, when the first touch sensor and the second touch sensor are not touched, the portable terminal may execute a particular function by a touch on the side key and/or the central on/off key.

A pattern for sensing a touch may be installed on the malfunction sensing unit.

According to another aspect of the present invention, there is provided, in a portable terminal including a function key configured as a touch key to execute a particular function, a method for executing the function key in a portable terminal The method includes a first step of sensing a touch on the function key, a second step of sensing a touch on a malfunction sensing unit disposed near the function key, and a third step of executing an operation corresponding to the touch on the function key.

The function key may include the side key and the central on/off key, and the first step may further include sensing a touch on both the side key and the central on/off key or a touch on at least one of the side key and the central on/off key.

The second step may further include, if a touch on the malfunction sensing unit is sensed when the central on/off key and/or the side key is touched, deactivating the touch on the central on/off key and/or the side key as the central on/off key and/or the side key is considered as erroneously touched.

The second step may further include, if the central on/off key and/or the side key is touched when the malfunction sensing unit is not touched, executing an operation corresponding to the touch on the central on/off key and/or the side key.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a perspective view schematically showing a portable terminal according to an embodiment of prior art;

FIG. 2 shows a rear side of a portable terminal shown in FIG. 1;

FIG. 3 is a plane view showing a portable terminal according to an exemplary embodiment of the present invention;

FIG. 4 is a perspective view showing a front surface of a main body of a portable terminal shown in FIG. 3;

FIG. 5 is a perspective view showing a rear surface of a main body of a portable terminal shown in FIG. 3;

FIGS. 6A through 6C show a state in which a pattern is formed for malfunction sensing units in a portable terminal shown in FIG. 3;

FIG. 7 is a block diagram of a portable terminal according to an embodiment of the present invention; and

FIG. 8 is a flowchart of a method for executing a function key in a portable terminal according to an embodiment of the present invention.

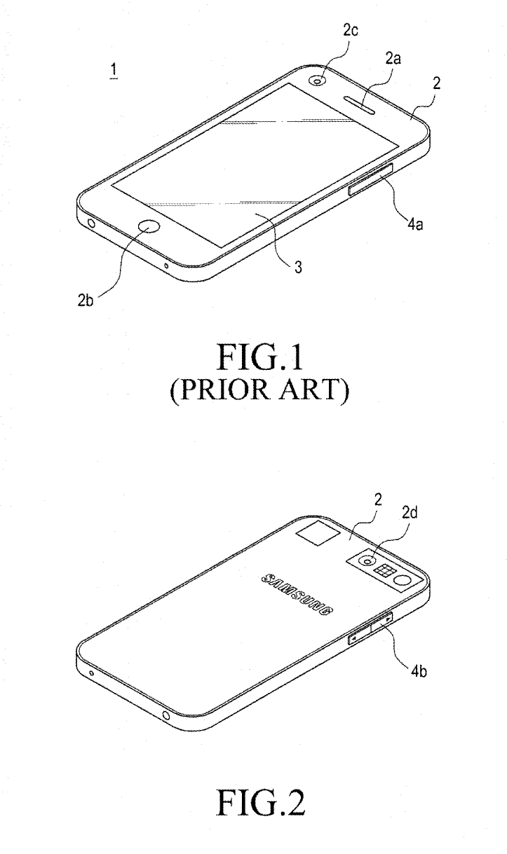

### DETAILED DESCRIPTION OF THE EXEMPLARY EMBODIMENT

Hereinafter, an exemplary embodiment of a portable terminal and a method for executing a function key included in the portable terminal according to the present invention will be described with reference to the accompanying drawings. In the following description, thicknesses of lines or sizes of components shown in the drawings may be exaggerated for clarity and convenience of the description. Terminologies used below are defined considering functions in the present invention, and the terminologies can be changed according to a user, an operator's intention, or custom as would be understood by one skilled in the art. Therefore, the definition must be drawn on the basis of contents over this specification. Although ordinal numbers such as “first”, “second”, etc., have been used in an embodiment of the present invention, they are merely intended to distinguish objects having the same name and their order may be set arbitrarily and the preceding description of an object may be applied to a next-order object. For the purposes of clarity and simplicity, well-known functions or constructions may not be described in detail as they would obscure appreciation of the present invention by a person of ordinary skill in the art with unnecessary detail of the well-known functions and structures.

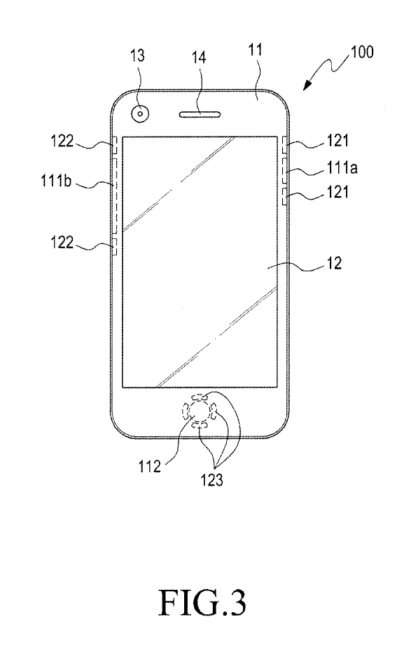

FIG. 3 is a plane view showing a portable terminal according to an exemplary embodiment of the present invention.

Referring to FIG. 3, a portable terminal 100 according to the present invention includes a main body 11, a touch panel 12, and function keys 111a, 111b, and 112. On a front surface of the main body 11 are provided a touch panel 12 for inputting/outputting data or providing an image, a sound output unit 14, and a camera 13, although the present invention is described as having particular functions and structures, one skilled in the art will understand that other alternates are also possible. The touch panel 12 displays or outputs various information of the portable terminal 100. For example, in a call mode, the touch panel 12 displays a User Interface (UI) or a Graphic User Interface (GUI) which is related to a call, or displays a captured or/and received image, a UI, a GUI, or the like in a video call or photographing mode.

The function keys 111a, 111b, and 112 are touch keys installed to execute preset particular functions by touches and sense occurrence of an unintended or erroneous touch, and the function keys 111a, 111b, and 112, disposed on a region of the main body 11 except for the touch panel 12 to execute particular functions, are all formed as touch keys. At least one of the function keys 111a, 111b, and 112 are disposed around the circumference of the touch panel 12. More specifically, the function keys 111a, 111b, and 112 include the central on/off key 112, the first and second side keys 111a and 111b, and malfunction sensing units 121, 122, and 123. The central on/off key 112, and/or the first and second side keys 111a and 111b, and the malfunction sensing units 121, 122, and 123 are all of a touch key type, such that particular functions are set in them, respectively, and they execute the different particular functions by touches, respectively. Preferably, the central on/off key 112, the first and second side keys 111a and 111b, and the malfunction sensing units 121, 122, and 123 have mounted thereon touch sensors in the form of a touch film, a touch sheet, a touch pad, or the like so as to sense a touch. That is, an applied pressure or a change in a capacitance due to touches on the first and second side keys 111a and 111b or the central on/off key 112 is converted into an electric input signal and a corresponding signal is transmitted to a controller 150. According to the signal transmitted to the controller 150, the first and second side keys 111a and 111b or the central on/off key 112 outputs(displays) a particular function corresponding to a set value (see FIG. 7).

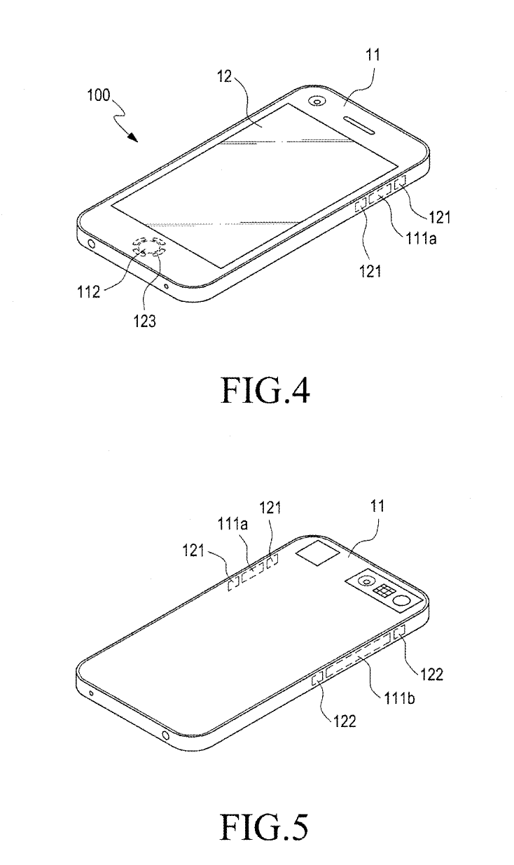

FIG. 4 is a perspective view showing a front surface of the main body 11 of the portable terminal 100 shown in FIG. 3, and FIG. 5 is a perspective view showing a rear surface of the main body 11 of the portable terminal 100 shown in FIG. 3.

Referring to FIGS. 4 and 5, the central on/off key 112 is disposed on the front surface of the main body 11, while being spaced apart from a lower portion of the touch panel 12. To execute a particular function by a touch of a user's finger, the central on/off key 112 may be a touch key. The central on/off key 112 executes particular functions disposed on the central on/off key 112, such as selection of output of an image or data onto the touch panel 12. In the current embodiment, it will be described as an example that the central on/off key 112 is assumed to be in a circular shape and the malfunction sensing unit 123 near the central on/off key 112 among the malfunction sensing units 121, 122, and 123 is disposed around the outer circumference of the central on/off key 112 in a concentric circular shape. However, the shape or particular function of the central on/off key 112 is not limited to the above example. For instance, the central on/off key 112 may be disposed in an alternate location such as at a side, rather than at the center of the main body 11, and may have other shapes than the circular shape, such as a square, oval, ellipsoid or rectangular shape. A function of the central on/off key 112 may be changed by a preset value according to a touch of the central on/off key 112. As such, the shape or function of the central on/off key 112 can be changed.

The malfunction sensing unit (or a first touch sensor) 123 among the malfunction sensing units 121, 122, and 123 is disposed around the concentric outer circumference of the central on/off key 112. The first touch sensor 123 is disposed near the circumference of the central on/off key 112, such that it is determined based on a touch of the first touch sensor 123 whether or not a touch of the central on/off key 112 and/or the first and/or second side key 111a and/or 111b is intended by a user, though a detailed structure of the first touch sensor 123 will be described later.

The first and second side keys 111a and 111b are provided as touch keys which execute particular functions by touches on sides of the main body 11. More specifically, the first and second side keys 111a and 111b include a first side touch key 111a and a second side touch key 111b which are disposed on both sides of the main body 11 to execute different functions by touches, respectively. The first side touch key 111a is a touch key disposed on a side of the main body 11 to execute a particular function by a touch, and the second side touch key 111b is a touch key disposed on the other side of the main body 11 to execute another particular function by a touch. That is, different particular functions are executed by touches of the first side touch key 111a and the second side touch key 111b respectively. More specifically, in the current embodiment, at least one of the first side touch key 111a and the second side touch key 111b is configured to execute a particular function in response to up/down by touches of an upper portion and a lower portion thereof For example, by touching the upper portion or lower portion of the first side touch key 111a, the user may cause the first side touch key 111a to execute a particular function of adjusting the volume of the portable terminal 100, moving a menu, or scrolling data. The other of the first side touch key 111a and the second side touch key 111b may be configured to execute the camera 13 or an MP3 function in response to a user's touch. In this way, a particular function of the portable terminal 100 may be executed according to input values set in the first and second side keys 111a and 111b. Different particular functions may be executed by touches of the central on/off key 112 and the first and second side touch keys 111a and 111b together, more specifically, touches of the first side touch key 111a and the second side touch key 111b together, touches of the first side touch key 111a and the central on/off key 112 together, touches of the second side touch key 111b and the central on/off key 112 together, or touches of the first and second side touch keys 111a and 111b and the central on/off key 112 all together. For example, when the first side touch key 111a and the second side touch key 111b are touched together, an operation of powering on/off the touch panel 12 may be executed; when the touches of the first side touch key 111a and the second side touch key 111b together are maintained for a predetermined time, e.g., 10 seconds, a particular function, such as locking execution of menus on the touch panel 12 or displaying an unlocking screen on the touch panel 12 to release the lock state, may be executed. One skilled in the art will recognize that other combinations of touches and functions are possible with respect to each key provided.

When the first and second side touch keys 111a and 111b and the central on/off key 112 are touched all together, a particular function of powering on/off the portable terminal 100 may be executed. Therefore, as the central on/off key 112 and the first and second side keys 111a and 111b are touched, a particular function is executed according to values which are preset in the respective keys 112, 111a, and 111b. Although several particular modes have been described as an example in the current embodiment, the present invention is not limited to that example and modes may be set variously according to functions included in the portable terminal 100. On the circumferences of the first and second side keys 111a and 111b, more specifically, above and under the first side touch key 111a and above and under the second side touch key 111b are disposed the malfunction sensing units 121 and 122 (or second touch sensors) among the malfunction sensing units 121, 122, and 123 to sense occurrence of an unintended or erroneous touch on the central on/off key 112 and the first and/or second side key 111a and/or 111b, as will be described in more detail when the malfunction sensing units 121, 122, and 123 are described below.

The malfunction sensing units 121, 122, and 123 are disposed around the circumferences of the function keys 111a, 111b, and 112, more specifically, around the circumferences of the first and second side keys 111a and 111b and the 20 central on/off key 112, respectively, to sense occurrence of an erroneous touch on the first and/or second side key 111a and/or 111b and/or the central on/off key 112. In this way, by disposing at least one of the malfunction sensing units 121, 122, and 123 around the circumferences of the function keys 111a, 111b, and 112, if a touch is generated on the central on/off key 112 and/or the first and/or second side key 111a and/or 111b during user's carrying of the portable terminal 100, the malfunction sensing units 121, 122, and 123 adjacent to those function keys 111a, 111b, and 112 are also touched, such that it is sensed that an unintended or erroneous touch is occurring on the central on/off key 112 and/or the first and/or second side key 111a and/or 111b. The malfunction sensing units 121, 122, and 123 include the first touch sensor 123 disposed around the circumference of the central on/off key 112, and the second touch sensors 121 and 122 disposed on the circumferences of the first and second side keys 111a and 111b, respectively.

The first touch sensor 123 is disposed around the circumference of the central on/off key 112, and in the current embodiment, is assumed to be disposed in four directions around the central on/off key 112. Hence, the first touch sensor 123 includes four touch sensors disposed near and around the central on/off key 112. Preferably in one embodiment, the first touch sensor 123 has a higher touch recognition rate than a touch sensor included in the central on/off key 112. Therefore, when a touch on the central on/off key 112 or the first and/or second side key 111a and/or 111b is not intended by the user, the first touch sensor 123 can accurately recognize the unintended touch, thus improving the reliability of a touch on the central on/off key 112 or the first and second side keys 111a and 111b.

For example, if a touch on the first touch sensor 123 is sensed when a touch on the central on/off key 112 is sensed, then the touch on the central on/off key 112 is considered or determined to be an erroneous touch, such that the central on/off key 112 is deactivated to prevent execution of a particular function corresponding to the touch on the central on/off key 112. If a touch on the first touch sensor 123 is sensed when a touch on the first and/or second side keys 111a and/or 111b is sensed, then the touch on the first and/or second side keys 111a and/or 111b is considered or determined to be an erroneous touch, such that the first and/or second side key 111a and/or 111b is deactivated to prevent execution of a particular function corresponding to the touches on the first and/or second side key 111a and/or 111b. If a touch on the first touch sensor 123 is sensed when touches on the central on/off key 112 and the first and/or second side key 111a and/or 111b together are sensed, then the touches on the central on/off key 112 and the first and/or second side key 111a and/or 111b are considered or determined to be to be erroneous touches, such that the central on/off key 112 and the first and/or second side key 111a and/or 111b are deactivated to prevent execution of a corresponding particular function. Therefore, according to occurrence of the touch on the first touch sensor 123, it is possible to determine whether the touches on the central on/off key 112 and/or the first and/or second side key 111a and/or 111b are not intended by the user, thereby preventing malfunction caused by the unintended or erroneous touches on the central on/off key 112 and/or the first and/or second side key 111a and/or 111b.

The second touch sensors 121 and 122 are disposed on the circumferences of the first and second side keys 111a and 111b, respectively, to sense unintended or erroneous touches on the central on/off key 112 and/or the first and/or second side key 111a and/or 111b. The second touch sensors 121 and 122 are disposed on the circumferences of the first and second side touch keys 111a and 111b, respectively. That is, the second touch sensors 121 and 122 include a first side touch sensor 121 disposed on the circumference of the first side touch key 111a and a second side touch sensor 122 disposed on the circumference of the second side touch key 111b. In the current embodiment, it is described as an exemplary embodiment that the first side touch sensor 121 is disposed near and adjacent to both end portions of the first side touch key 111a on a side of the main body 11 and the second side touch sensor 122 is disposed near and adjacent to both end portions of the second side touch key 111b on the other side of the main body 11. However, the positions or numbers of the first side touch sensor 121 and the second side touch sensor 122 are not limited to that example, and may be changed as long as the first side touch sensor 121 and the second side touch sensor 122 are disposed near the edge or circumferences of the first and second side touch keys 111a and 111b to sense an unintended or erroneous touch on the first and/or second side touch key 111a and/or 111b and/or an erroneous touch on the central on/off key 112. That is, preferably, the second touch sensors 121 and 122 of the same number as the side keys 111a and 111b provided in the main body 11 are provided. For example, if the first and second side keys 111a and 111b are disposed only on a side of the main body 11, e.g., only the first side touch key 111a is provided in the main body 11, then the second touch sensors 121 and 122 are provided only on the circumferences of the first side touch key 111a. In addition, for instance, if the first and second side keys 111a and 111b are disposed on both sides and top and bottom portions of the main body 11, then the second touch sensors 121 and 122 may be disposed on the circumferences of the four side keys 111a and 111b, respectively. In this way, various modified embodiments may be possible.

Preferably, the second touch sensors 121 and 122 have a higher touch recognition rate than touch sensors disposed in the first and second side keys 111a and 111b. Therefore, when a touch on the central on/off key 112 or the first and/or second side key 111a and/or 111b is not intended by the user, then the second touch sensors 121 and 122 can accurately recognize the unintended touch, thus improving the reliability of a touch on the central on/off key 112 or the first and second side keys 111a and 111b.

For example, if a touch on the first side touch sensor 121 and/or the second side touch sensor 122 is sensed when an up/down position of the first side touch key 111a is touched, then the touch on the first side touch key 111a is considered or determined to be an erroneous touch, such that the first side touch key 111a is deactivated and a particular function corresponding to the touch on the first side touch key 111a is not executed. If a touch on the first side touch sensor 121 and/or the second side touch sensor 122 is sensed when a touch on the second side touch key 111b is sensed, then the touch on the second side touch key 111b is considered or determined to be an erroneous touch, such that the second side touch key 111b is deactivated to prevent a particular function corresponding to the touch on the second touch key 111b from being executed. If a touch on the first touch sensor 123 and/or the second touch sensors 121 and/or 122 is sensed when the first and second side touch key 111a and 111b are touched, then the first and second side touch key 111a and 111b is considered or determined to be erroneously touched, such that the first and second side touch key 111a and 111b is deactivated to prevent execution of a particular function corresponding to the touches on the first and second side touch key 111a and 111b.

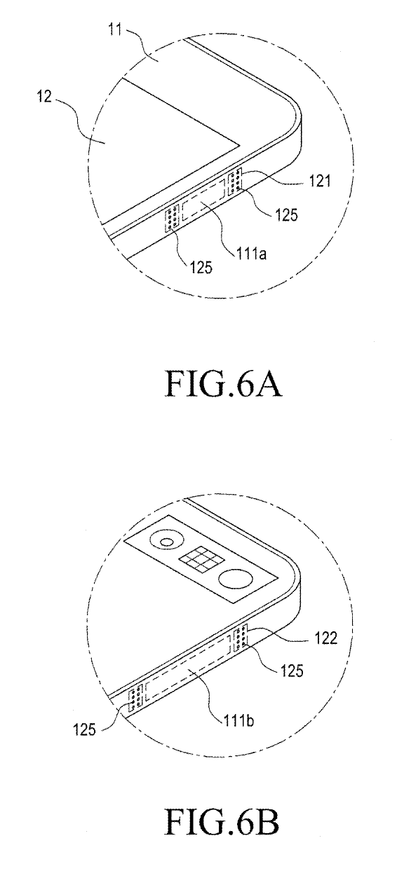

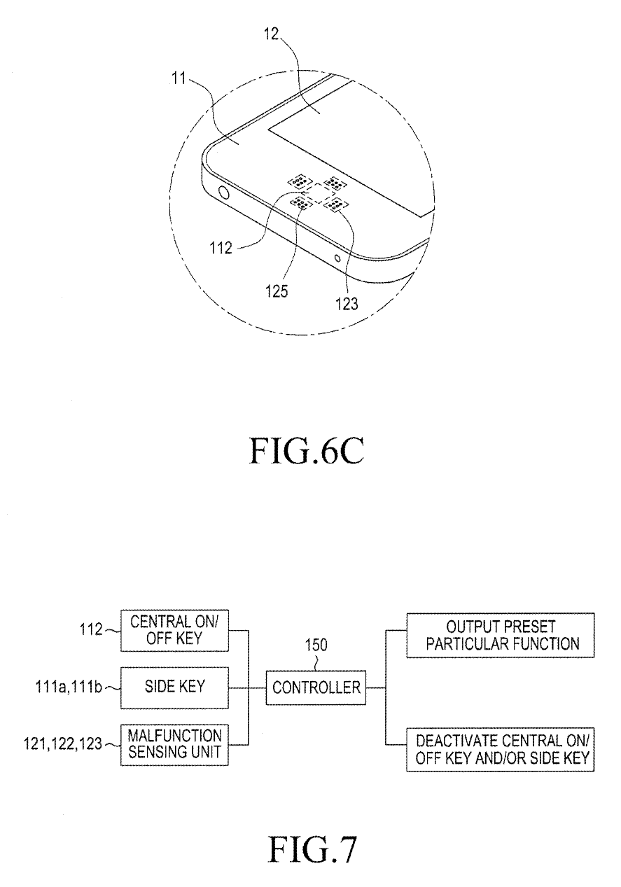

FIGS. 6A through 6C show a state in which a pattern is formed in the malfunction sensing units 121, 122, and 123 in the portable terminal 100 shown in FIG. 3. Referring to FIGS. 6A through 6C, a pattern 125 that the user can perceive tactually or visually, such as protrusions or designs, is formed in the first touch sensor 123 and the second touch sensors 121 and 122. Thus, when the user touches the central on/off key 112 and/or the first and/or second side key 111a and/or 111b, touches on the malfunction sensing units 121, 122, and 123 are prevented so as to improve the reliability of touches on the central on/off key 112 and/or the first and second side keys 111a and 111b. For example, in the current embodiment, the pattern 125 includes a plurality of protrusions, such that when touching the central on/off key 112 and/or the first and/or second side key 111a/or and 111b by hand to execute a particular function, the user avoids touching the malfunction sensing units 121, 122, and 123 due to the user sensing the protrusions. Subsequently, the user can touch only the central on/off key 112 and the first and/or second side key 111a and/or 111b without touching the malfunction sensing units 121, 122, and 123, thus improving the reliability of touches on the function keys 111a, 111b, and 112.

While the pattern 125 formed in the malfunction sensing units 121, 122, and 123 uses protrusions as an example, the present invention is not limited to that example, and the pattern 125 may have various forms. For example the malfunction sensing units 121, 122 may, emit light when touched or provide other visual or tactual feedback to the user so that, the user can sense positions of or touches on the malfunction sensing units 121, 122, and 123.

Although not shown in the current embodiment, a haptic module may be mounted to allow the user to feel a touch on the central on/off key 112 and the first and/or second side key 111a and/or 111b, which are provided as touch keys.

Vibration is a representative example of a tactile effect generated by the haptic module; at a moment when the user touches the central on/off key 112 and/or the first and/or second side key 111a and/or 111b without touching the malfunction sensing units 121, 122, and 123, the controller 150 senses those touches and controls driving of the haptic module. Consequently, the user can perceive the touches on the central on/off key 112 and/or the first and/or second side key 111a and/or 111b.

FIG. 7 is a block diagram of the portable terminal 100 according to the present invention. Referring to FIG. 7, the controller 150 receives a signal in response to sensing of a touch on the central on/off key 112, the first and/or second side key 111a and/or 111b, and the malfunction sensing units 121, 122, and 123, and controls execution of a corresponding operation. That is, if a touch on at least one of the first touch sensor 123 and the second touch sensors 121 and 122 is sensed when the central on/off key 112 is touched, the first and/or second side key 111a and/or 111b is touched, or the central on/off key 112 and the first and/or second side key 111a and/or 111b are touched, then the touch on the central on/off key 112 and/or the first and/or second side key 111a and/or 111b is considered or determined to be an erroneous touch, such that the controller 150 controls the touch on the central on/off key 112 and/or the first and/or second side key 111a and/or 111b to be deactivated so as to prevent execution of a particular function corresponding to the touch on the central on/off key 112 and/or the first and/or second side key 111a and/or 111b.

If a touch on either the first touch sensor 123 or the second touch sensor 121 and/or 122 is not generated when the central on/off key 112 and/or the first and/or second side key 111a and/or 111b is touched, then the controller 150 controls a particular function corresponding to the touch on the central on/off key 112 and/or the first and/or second side key 111a and/or 111b to be executed. That is, as already described above, when the malfunction sensing units 121, 122, and 123 are not touched, a particular function may be executed, for example, the portable terminal 100 is powered on/off if the first and/or second side touch key 111a and/or 111b and the central on/off key 112 are touched at the same time, or the locking of the touch panel 12 provided in the portable terminal 100 is turned on or off if the first side touch key 111a and the second side touch key 111b are touched at the same time.

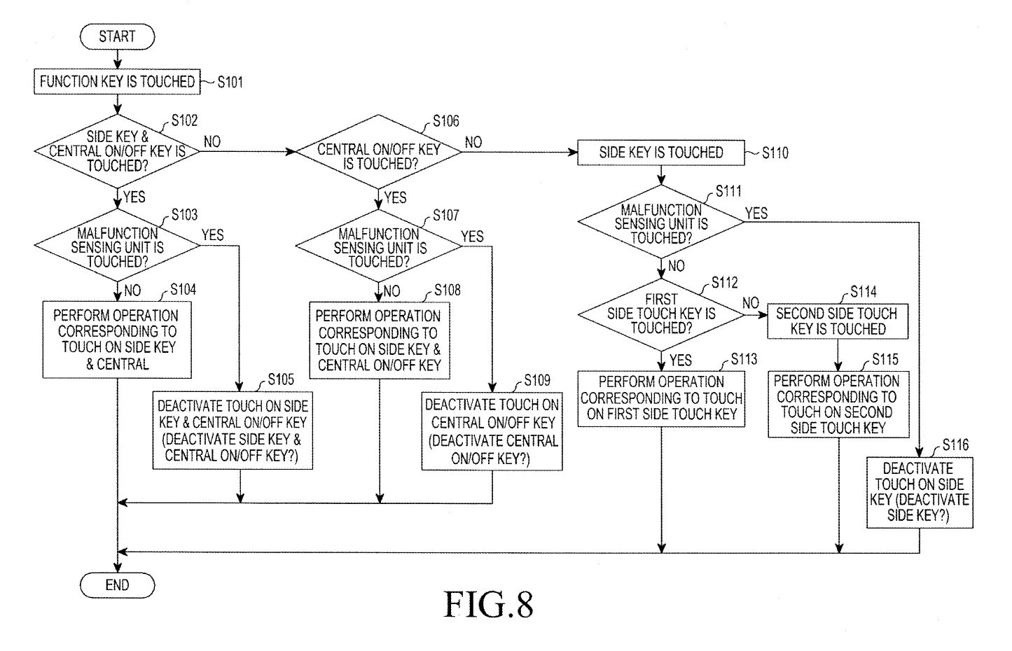

In the portable terminal 100 in which the function keys 111a, 111b, and 112 included in the main body 11, such as the first and/or second side key 111a and/or 111b and/or the central on/off key 112, are provided as touch keys, the function keys 111a, 111b, and 112 are executed as shown in FIG. 8 which is a flowchart of a method for executing the function keys 111a, 111b, and 112 in the portable terminal 100 according to an embodiment of the present invention.

Referring to FIG. 8, the method for executing the function keys 111a, 111b, and 112 in the portable terminal 100 includes first steps S102, S106, and S110 of sensing a touch on the function keys 111a, 111b, and 112 that are of a touch key type provided in the main body 11, such as the central on/off key 112 and/or the first and second side keys 111a and 111b, then due to generation of the touch on the function keys 111a, 111b, and 112 in S101; second steps S103, S107, and S111 of sensing a touch on the malfunction sensing units 121, 122, and 123 disposed near the function keys 111a, 111b, and 112; if no touch of the malfunction sensing unit is sensed in steps S103, S107 and S111, then executing third steps S104, S108, and S112, are performed. If a touch of the malfunction sensing unit is sensed in steps S103, S107 and S111, then steps S105, S109 and S116 are executed. With respect to S112, if the first side touch key is touched then S113 is executed and the operation corresponding to the touch on the first side key is performed. If in S112 no touch is sensed of the first side touch key, then in S114 it is determined if the second side touch key is touched, if yes, then in S115, the performing an operation corresponding to the touch on the function keys 111a, 111b, and 112 is executed.

In the first steps, once touches on both the first and/or second side key 111a and/or 111b and the central on/off key 112 are sensed in S102, then it is sensed whether a touch on the first touch sensor 123 disposed around the circumference of the central on/off key 112 and/or a touch on the second touch sensor 121 and/or 122 disposed on the circumferences of the first and second side keys 111a and 111b is generated in S103.

In S103 in which malfunction is sensed, if a touch on the malfunction sensing units 121, 122, and 123 is not sensed when the first and/or second side key 111a and/or 111b and the central on/off key 112 are touched, then the touches on the first and/or second side key 111a and/or 111b and the central on/off key 112 are normal touches, such that a corresponding operation is performed in S104. For example, if the first side touch key 111a and the central on/off key 112 are touched at the same time, then the camera 13 may operate; if the second side touch key 111b and the central on/off key 112 are touched at the same time, then an MP3 file may be reproduced. If the first side touch key 111a, the second side touch key 111b, and the central on/off key 112 are touched all together, then the portable terminal 100 may be powered on/off. In this way, a preset particular function is executed correspondingly. One skilled in the art will recognize that any combination of touches may be used to correspond to a particular predetermined function or operation.

In step S103 of sensing malfunction, if a touch on at least one of the first touch sensor 123 and the second touch sensor 121 and/or 122 is sensed, then the touches on the first and/or second side key 111a and/or 111b and the central on/off key 112 are considered or determined to be erroneous touches, such that the first and/or second side key 111a and/or 111b and the central on/off key 112 are deactivated to prevent execution of a function corresponding to the touches on the first and/or second side key 111a and/or 111b and the central on/off key 112 in S105.

In the first steps, once a touch on the central on/off key 112 is sensed in S106, then it is determined whether a touch on the malfunction sensing units 121, 122, and 123 is also generated in S107. If a touch on either the first touch sensor 123 or the second touch sensor 121 and/or 122 is not sensed, then the touch on the central on/off key 112 is determined to be a normal touch, such that a corresponding preset operation is performed in S108. That is, if execution of a main menu is preset to be turned on or off in case of a touch on the central on/off key 112, then execution of the main menu is turned on/off by a normal touch on the central on/off key 112. However, in step S107 of sensing a touch on the malfunction sensing units 121, 122, and 123, if a touch on at least one of the first touch sensor 123 and the second touch sensors 121 and 122 is sensed, then the touch on the central on/off key 112 is determined to be an erroneous touch, such that the touch on the central on/off key 112 is deactivated to prevent execution of a preset operation corresponding to the touch on the central on/off key 112 in S109.

In the first steps, once a touch on the first and/or second side key 111a and/or is sensed in S110, it is determined whether the malfunction sensing units 121, 122, and 123 are also concurrently touched in S111. In S111 it is determined if there is a touch on the malfunction sensing units 121, 122, and 123, if a touch on either the first touch sensor 123 or the second touch sensor 121 and/or 122 is not sensed, then it is recognized that the touch on the first and/or second side key 111a and/or 111b is a normal touch, and thus a corresponding preset operation is performed. If it is determined that a touch on the first side touch key 111a is generated in S112, then an operation corresponding to the touch on the first side touch key 111a is performed in S113; if it is determined that a touch on the second side touch key 111b is generated in S114, then an operation corresponding to the touch on the second side touch key 111b is performed in S115. That is, if the sound, such as volume, is preset to be turned up or down or up/down movement of a menu selection bar is preset by the touch on the first and/or side key 111a and/or 111b, then the sound is turned up/down or the menu selection bar is moved up/down by a normal touch on the first and/or second side key 111a and/or 111b.

However, in S111 while sensing a touch on the malfunction sensing units 121, 122, and 123, if a touch on at least one of the first touch sensor 123 and the second touch sensors 121 and 122 is sensed, then a touch on the first and/or second side key 111a and/or 111b is determined to be an erroneous touch, such that the touch on the first and/or second side key 111a and/or 111b is deactivated to prevent execution of a function corresponding to the touch on the first and/or second side key 111a and/or 111b in S116.

Therefore, by providing the function keys 111a, 111b, and 112 disposed in the portable terminal 100, such as the first and second side keys 111a and 111b and/or the central on/off key 112, as touch keys, and disposing the malfunction sensing units 121, 122, and 123 near and adjacent to the function keys 111a, 111b, and 112 to sense an inadvertent or erroneous touch, the reliability of the function keys 111a, 111b, and 112 of a touch key type can be improved.

The portable terminal and the method for executing a function key in the portable terminal, which are configured as described above, provide the side key and/or the central on/off key as touch keys, thereby providing robustness against breakdown and easiness in operation to users.

In addition, by disposing the malfunction sensing units near the side key or the central on/off key of a touch key type, malfunction caused by a touch which is not intended by a user or an inadvertent or erroneous touch can be solved, thereby improving the reliability of the side key and the central on/off key.

Moreover, various functions can be executed according to various methods of touching the side key and the central on/off key.

Furthermore, when compared to a conventional mechanical button key, a touch key is easy to assemble, thus reducing working procedures, solves a defect in the sense of click of the side key or the central on/off key, and has no gap or space which is likely to introduce a foreign substance into the main body, thus providing a more waterproof portable terminal property and preventing a problem which may occur due to the foreign substance.

According to whether the side key and/or the central on/off key is touched, various functions may be executed.

While a detailed embodiment of the present invention has been described, various modifications can be carried out without departing from the scope of the present invention. Therefore, the scope of the invention is not defined by the foregoing embodiment of the invention, but should be defined by claims and equivalents thereof Furthermore, the above-described methods according to the present invention can be implemented in hardware, firmware or as software or computer code that can be stored in a recording medium such as a CD ROM, an RAM, a floppy disk, a hard disk, thumbnail drive or a magneto-optical disk or computer code downloaded over a network originally stored on a remote recording medium or a non-transitory machine readable medium and to be stored on a local non-transitory recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

What is claimed is:

1. A portable terminal comprising a main body, an on/off key provided on a top surface of the main body, and at least one side key provided on a side of the main body, wherein the central on/off key and/or the side key are configured as touch keys.

2. The portable terminal of claim 1, wherein the central on/off key and/or the side key comprises at least one malfunction sensing unit which is disposed around and on circumferences thereof, respectively, the malfunction sensing unit comprising a touch sensor.

3. The portable terminal of claim 2, wherein if a touch on the malfunction sensing unit is sensed when the central on/off key and/or the side key is touched, the central on/off key is determined to be inadvertently touched.

4. The portable terminal of claim 2, wherein a particular function is executed as the central on/off key and/or the side key is touched.

5. The portable terminal of claim 4, wherein the side key comprises:
a first side touch key disposed on a side of the main body to execute a particular function by being touched; and
a second side touch key disposed on the other side of the main body to execute a particular function by being touched, which is different from the function of the first side touch key,.

6. The portable terminal of claim 4, wherein the malfunction sensing unit comprises:
a first touch sensor disposed around the circumference of the central on/off key to sense an inadvertent touch on the central on/off key and/or the side key; and
a second touch sensor disposed on the circumference of the side key to sense an inadvertent touch on the central on/off key and/or the side key.

7. The portable terminal of claim 6, wherein the second touch sensor comprises:
a first side touch sensor disposed on the circumference of the first side key; and
a second side touch sensor disposed on the circumference of the second side key.

8. The portable terminal of claim 5, wherein a pattern for sensing a touch on the first touch sensor and the second touch sensor is formed on the first touch sensor and the second touch sensor.

9. The portable terminal of claim 5, wherein if the first side touch key and the second side touch key are touched at the same time when the malfunction sensing unit is not touched, the locking function of a touch panel provided in the portable terminal is turned on/off.

10. The portable terminal of claim 5, wherein if the first and second side touch keys and the central on/off key are touched at the same time when the malfunction sensing unit is not touched, the portable terminal is powered on/off.

11. A portable terminal comprising a touch panel disposed in a main body of the portable terminal, wherein function keys disposed in the portable terminal comprise touch keys and sense an inadvertent touch on the function keys.

12. The portable terminal of claim 11, wherein the function keys comprise:
a central on/off key disposed apart from the touch panel;
a side key disposed on a side of the main body; and
a malfunction sensing unit comprising a first touch sensor disposed around the circumference of the central on/off key and a second touch sensor disposed on the circumference of the side key.

13. The portable terminal of claim 12, wherein the first touch sensor and the second touch sensor have a higher touch recognition rate than the side key and the central on/off key.

14. The portable terminal of claim 13, wherein if a touch on the first touch sensor and/or the second touch sensor is sensed when the central on/off key is touched, the central on/off key is determined to be inadvertently touched.

15. The portable terminal of claim 13, wherein if a touch on the first touch sensor and/or the second touch sensor is sensed when the side key is touched, the side key is determined to be inadvertently touched.

16. The portable terminal of claim 13, wherein when the first touch sensor and the second touch sensor are not touched, the portable terminal executes a particular function by a touch on the side key and/or the central on/off key.

17. The portable terminal of claim 12, wherein a pattern for sensing a touch is formed on the malfunction sensing unit.

18. In a portable terminal comprising a function key configured as a touch key to execute a particular function, a method for executing the function key in a portable terminal, the method comprising:
a first step of sensing a touch on the function key;
a second step of sensing a touch on a malfunction sensing unit disposed near the function key; and
a third step of executing an operation corresponding to the touch on the function key.

19. The method of claim 18, wherein the function key comprises the side key and the central on/off key, and the first step further comprises sensing a touch on both the side key and the central on/off key or a touch on at least one of the side key and the central on/off key.

20. The method of claim 19, wherein the second step further comprises, if a touch on the malfunction sensing unit is sensed when the central on/off key and/or the side key is touched, deactivating the touch on the central on/off key and/or the side key as the central on/off key and/or the side key is determined to be inadvertently touched.

21. The method of claim 19, wherein the second step further comprises, if the central on/off key and/or the side key is touched when the malfunction sensing unit is not touched, executing an operation corresponding to the touch on the central on/off key and/or the side key.
